(19) United States
(12) Patent Application Publication
(10) Pub. No.: US 2018/0133892 A1
(43) Pub. Date: May 17, 2018

(54) Tool Rack

(71) Applicant: Chase Mims, Mansfield, TX (US)

(72) Inventor: Chase Mims, Mansfield, TX (US)

(21) Appl. No.: 15/350,029

(22) Filed: Nov. 12, 2016

(51) Int. Cl. B25H 3/04; B25H 3/00

(52) U.S. Cl. CPC B25H 3/04; B25H 3/006

(57) ABSTRACT

A tool holder for holding a tool may include a front wall; a back wall opposed to the front wall; a pair of opposing side walls to connect the front wall to the back wall; and a bottom wall to connect the front wall, the back wall, and the side walls. The front wall includes a curved edge to support a grinding tool.

### FIELD OF THE INVENTION

The present invention relates to a tool rack and more particularly to a tool rack for a two angle grinder.

### BACKGROUND

Tool racks have been used by workmen ever since tools have been used. The more specialized a tool becomes the more need there is for a specialized tool rack.

### SUMMARY

A tool holder for holding a tool may include a front wall; a back wall opposed to the front wall; a pair of opposing side walls to connect the front wall to the back wall; and a bottom wall to connect the front wall, the back wall, and the side walls. The front wall includes a curved edge to support a grinding tool.

The tool rack may include a first compartment to hold welding rod pouches.

The tool rack may include a second compartment to hold three-way plugs.

The tool rack may include a third compartment to provide a third compartment.

The tool rack may include a fourth compartment to provide easy access to the grinder.

The tool rack may include an a fourth compartment for necessary tools for welders/fitters.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a bottom view of the tool rack of the present invention;

FIG. 2 illustrates a top view of the tool rack of the present invention;

FIG. 3 illustrates a back perspective view of the tool rack of the present invention;

FIG. 4 illustrates a side view of the tool rack of the present invention;

FIG. 5 illustrates a front view of the tool rack of the present invention;

FIG. 6 illustrates another side view of the tool rack of the present invention.

### DETAILED DESCRIPTION

The tool holding device of the present invention may be a tool rack which may be formed to fit a multitude of vehicles including scissor lifts, boom lifts, and one man lifts of every kind. The tool holding device of the present invention may be formed to fit lifts with guard rails which may be round, square or other shaped tubing. The tool holding device of the present invention may be to hold two angle grinders sizes including from substantially four-inch to 6 inch. The tool holding device of the present invention is to hold one end grinders which are also known as pencil grinders. In addition, the sections of the tool holding device may hold all necessary tools for welders and fitters. The tool holding device of the present invention brings safety and protection to the job site.

Section A (the first top wall 105) is a seat for the pipe hands tool rack. This section lies over the circular or square tubing providing a connection for a secure close fit.

Section B (the horizontal wall 111) gives strength to the structure holding screws that move very easily by twisting of the fingers. The screws screw up to attach the bottom of the circular or square tubing to secure the pipe hands tool rack to the frame of the lift without damaging the integrity of the frame.

Section C (container 127) is a half circular link that holds welding rod pouches or other tools that has a clip.

Section D (feet 115) is hooks to hold pipe wrenches, levels, grind/cutting disks or other tools keeping them off the floor of the lift.

Section E (E compartment 139) and holds all sizes of three way plugs. It cups the three-way plugs out towards the grinders for easy access of plugging and unplugging angle/end grinders. This was included so that no cords need to be tied to the left, possibly causing it to flip. This gives the opportunity for the extension cord and three way to separate if the chord gets tangled or caught allowing the lift to break free.

Section F (element 141) is the compartment that holds the end grinder for a safe and tucked away environment with open ends.

Section G (element 143) cups between the angle grinder guard and grinder to secure the grinder from movement. It keeps easy access to the grinder and off the floor for potential injury from stepping on the trigger. This grinder compartment is blocked off from (H) to keep tools away from the blades that would keep the grinder from having a secure seat.

Section H (element 145) holds all necessary tools for a welders/fitters task, keeping easy access to tools for the safety and protection of the tasks at hand.

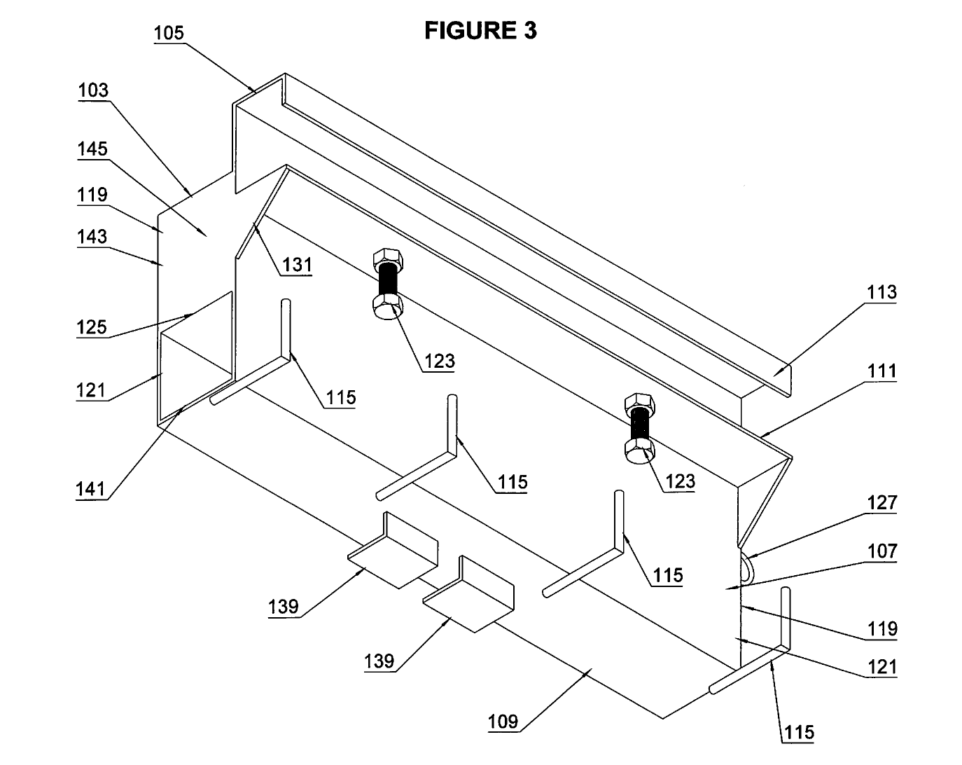

FIG. 3 illustrates a back perspective view of the tool rack 100 of the present invention, and the tool rack 100 may include a back wall 107 which may be opposed to a front wall 103. The front wall 103 may be connected to the back wall 107 by a bottom wall 109 and by a separating bottom wall 125. Additionally, the front wall 103 may be connected to the back wall 107 by a pair of opposing first side wall 119 and a second side wall 121.

The back wall 107 may be connected to a first top wall 105 which may extend across the top of the tool rack 100 and which may be connected to a vertical wall 113 which may form a channel to hang the tool rack 100.

FIG. 3 additionally illustrates a horizontal wall 111 which may be in a spaced relationship with respect to the first top wall 105 and which may be connected to a support wall 131 which may connect the horizontal wall 111 with the back wall 107. The horizontal wall 111 may include apertures which may be threaded to threadably connect with fasteners 123 to allow the tool (not shown) to be detachably connected to the tool rack 100.

The bottom wall 109 may be connected to L-shaped feet 115 to provide support to a support surface to the tool rack 100.

FIG. 3 additionally illustrates the position of the F compartment 141, the G compartment and the H compartment 145.

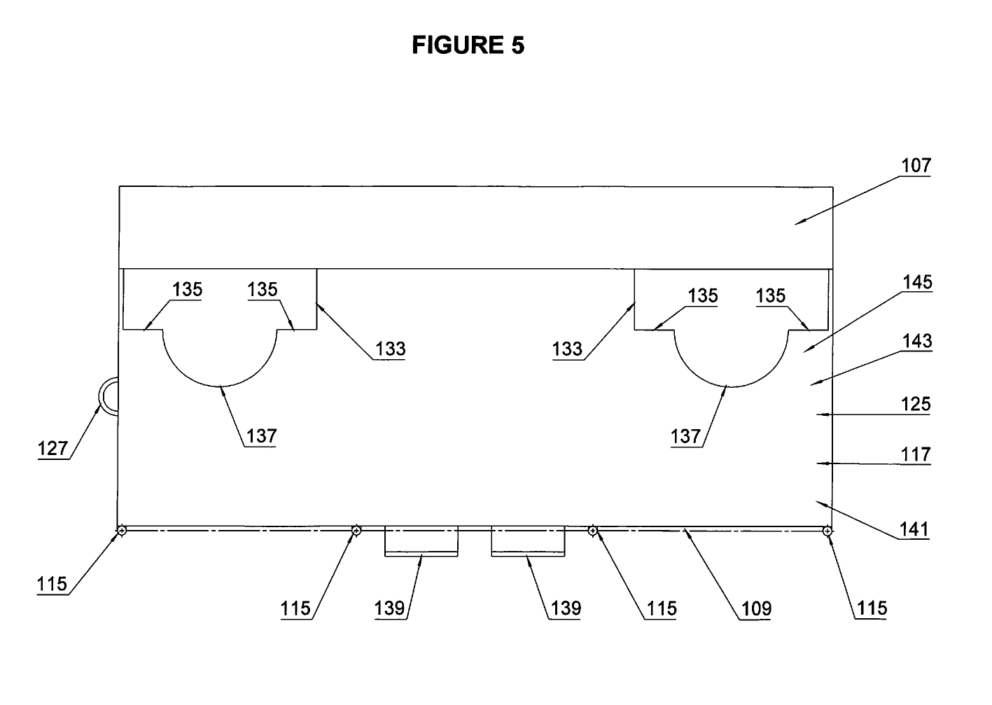

FIG. 5 illustrates a front view of the tool rack 100 and illustrates the back wall 107 which opposes the front retainer wall 117 which may extend the entire width of the tool rack 100 and may extend a portion of the height of the back wall 107. The front retainer wall 117 may include a pair of opposing cut out sections 131, and the cutout sections 131 may be defined by a vertical edge 133, a pair of horizontal edges 135 and a concave curved edge 137. FIG. 5 additionally illustrates the feet 115, a pair of E compartments 139 which may be positioned beneath the bottom wall 109.

FIG. 5 additionally illustrates the position of the F compartment 141, the G compartment 143 and the H compartment 145.

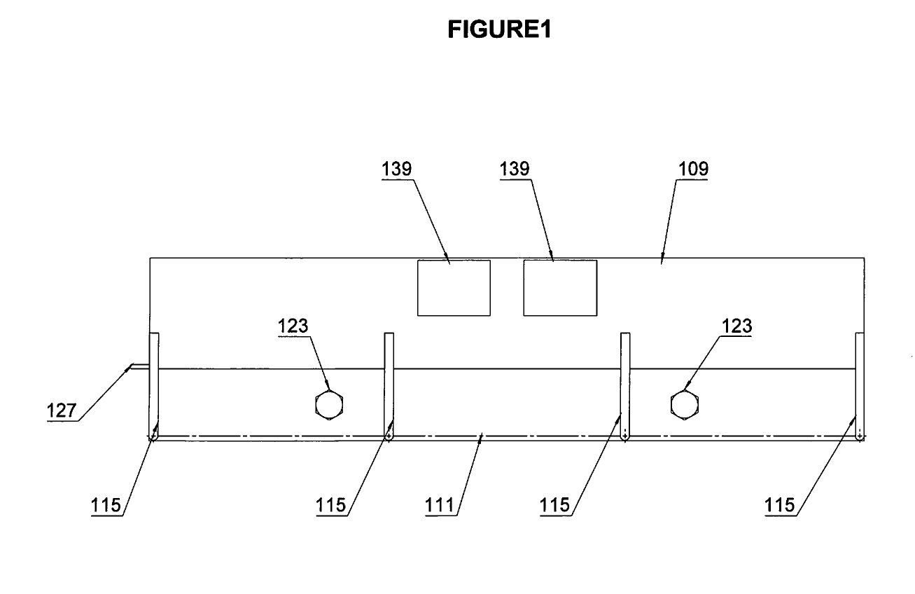

FIG. 1 illustrates a bottom view of the tool rack 100 and illustrates the E compartment 139, the bottom wall 109, the feet 115, and the fasteners 123.

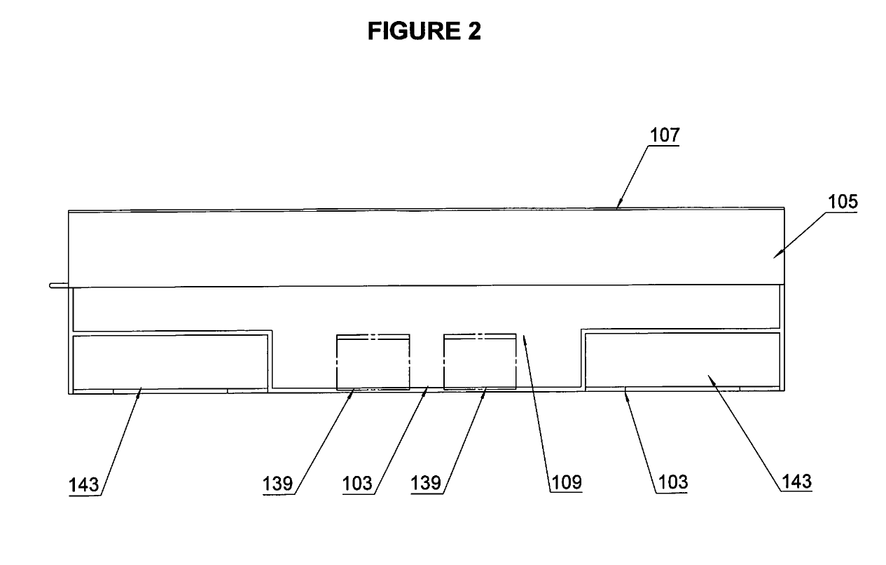

FIG. 2 illustrates a top view of the tool rack 100 of the present invention and illustrates the first top wall 105, the back wall 107, the front wall 103, the bottom wall 109, the E compartment 139, and the G compartment 143.

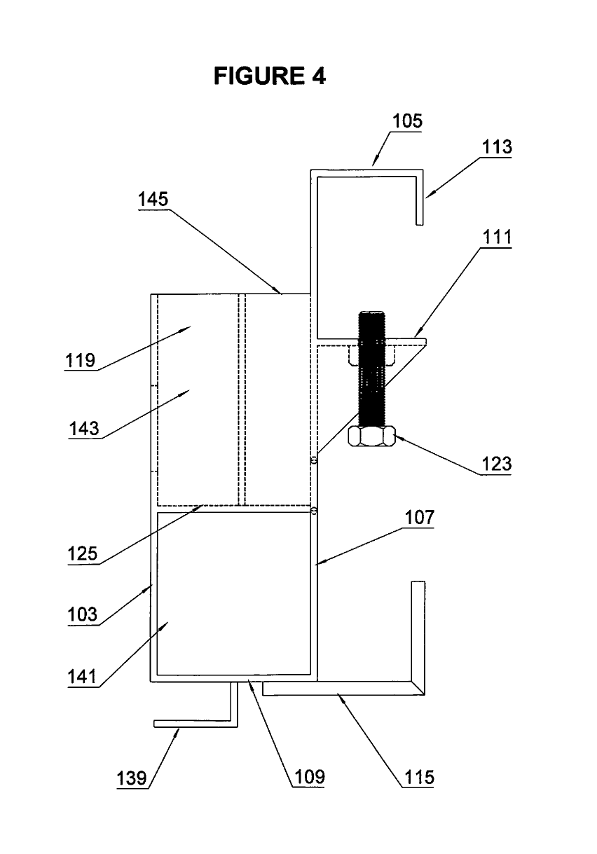

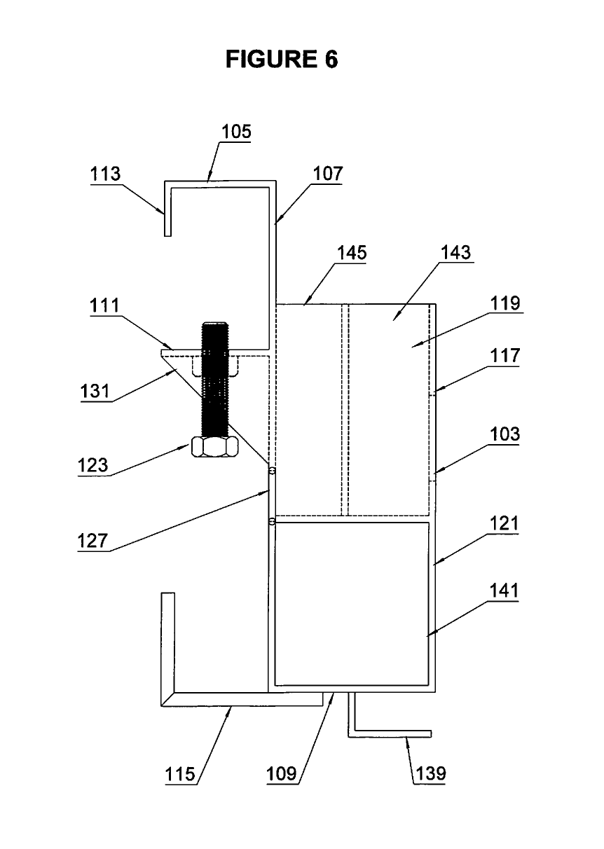

FIGS. 4 and 6 illustrates a side view of the tool rack 100 of the present invention, and the tool rack 100 may include a back wall 107 which may be opposed to a front wall 103. The front wall 103 may be connected to the back wall 107 by a bottom wall 109 and by a separating bottom wall 125. Additionally, the front wall 103 may be connected to the back wall 107 by a pair of opposing first side wall 119 and a second side wall 121.

The back wall 107 may be connected to a first top wall 105 which may extend across the top of the tool rack 100 and which may be connected to a vertical wall 113 which may form a channel to hang the tool rack 100.

FIGS. 4 and 6 additionally illustrates a horizontal wall 111 which may be in a spaced relationship with respect to the first top wall 105 and which may be connected to a support wall 131 which may connect the horizontal wall 111 with the back wall 107. The horizontal wall 111 may include apertures which may be threaded to threadably connect with fasteners 123 to allow the tool (not shown) to be detachably connected to the tool rack 100.

The bottom wall 109 may be connected to L-shaped feet 115 to provide support to a support surface to the tool rack 100.

FIGS. 4 and 6 additionally illustrates the position of the F compartment 141, the G compartment and the H compartment 145.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A tool holder for holding a tool, comprising:
a front wall;
a back wall opposed to the front wall;
a pair of opposing side walls to connect the front wall to the back wall;
a bottom wall to connect the front wall, the back wall, and the side walls;
and wherein the front wall includes a curved edge to support a grinding tool.

2) A tool holder for holding a tool as in claim 1, wherein the tool rack includes a first compartment to hold welding rod pouches.

3) A tool holder for holding a tool as in claim 1, wherein the tool rack includes a second compartment to hold three-way plugs.

4) A tool holder for holding a tool as in claim 1, wherein the tool rack includes a third compartment to provide a third compartment.

5) A tool holder for holding a tool as in claim 1, wherein the tool rack includes a fourth compartment to provide easy access to the grinder.

6) A tool holder for holding a tool as in claim 1, wherein the tool rack includes a fourth compartment for necessary tools for welders/fitters.
